(19) United States
(12) Patent Application Publication
(10) Pub. No.: US 2012/0264403 A1
(43) Pub. Date: Oct. 18, 2012

(54) COMMUNICATION CONTROL SYSTEM AND METHOD THEREOF

(75) Inventors: KUAN-HONG HSIEH, Tu-Cheng (TW); MING-TSUNG CHEN, Tu-Cheng (TW); HUI-FANG PENG, Shenzhen City (CN); YAN-LING ZHANG, Shenzhen City (CN)

(73) Assignees: HON HAI PRECISION INDUSTRY CO., LTD., Tu-Cheng (TW); HONG FU JIN PRECISION INDUSTRY (SHENZHEN) CO., LTD., Shenzhen City (CN)

(21) Appl. No.: 13/190,485

(22) Filed: Jul. 26, 2011

(30) Foreign Application Priority Data
Apr. 18, 2011 (CN) 201110096494.4

(51) Int. Cl. H04W 4/02; H04W 4/12

(52) U.S. Cl. 455/412.1; 455/418; 455/41.3

(57) ABSTRACT

A communication control system includes an electronic device and a communication apparatus paired with the electronic device. The electronic device includes an input unit, a first BLUETOOTH unit, and a dialing control module. The input unit generates commands in response to operations of a user. The dialing control module generates dial information when a dialing command is received, and controls the first BLUETOOTH unit to transmit the dial information to the communication apparatus. The communication apparatus includes a wireless communication unit, a second BLUETOOTH unit, and a dialing module. The dialing module controls the wireless communication unit to dial according to the dial information. The dialing module also controls the second BLUETOOTH unit to transmit real-time dial information and voice signals of the user to the electronic device. A related method is also provided.

### BACKGROUND

1. Technical Field

The present disclosure relates to a communication control system and method thereof.

2. Description of Related Art

Electronic devices such as digital photo frames, and tablet computers, can transfer data to other electronic devices via BLUETOOTH. However, the electronic device cannot dial or answer a call via a wireless communication apparatus such as a mobile phone with BLUETOOTH. In addition, the electronic device cannot show an incoming call or an incoming message of the mobile phone for a user to answer the call or read the messages via the electronic device that is in use, which can be inconvenient.

Therefore, what is needed is a communication control system and method thereof to alleviate the limitations described above.

### BRIEF DESCRIPTION OF THE DRAWINGS

The components in the drawings are not necessarily drawn to scale, the emphasis instead being placed upon clearly illustrating the principles of an communication control system and method thereof. Moreover, in the drawings, like reference numerals designate corresponding sections throughout the several views.

FIG. 1 is a block diagram of a communication control system in accordance with an exemplary embodiment.

FIG. 2 is a flowchart of a communication control method for communication control systems, such as the one of FIG. 1, illustrating the electronic device communicating with another communication device via the communication apparatus, in accordance with the exemplary embodiment.

FIG. 3 is a flowchart of a communication control method for communication control systems, such as the one of FIG. 1, illustrating the communication apparatus transmitting the communication data to the electronic device, in accordance with the exemplary embodiments.

### DETAILED DESCRIPTION

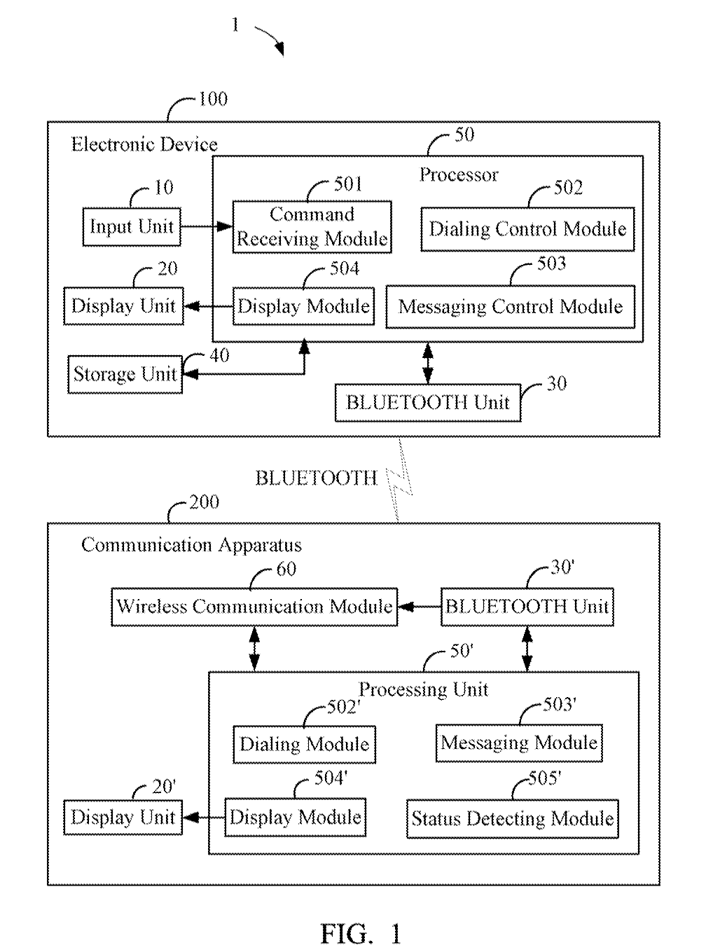

Referring to FIG. 1, a communication control system 1 is disclosed as an exemplary embodiment. The communication control system 1 includes an electronic device 100 equipped with a display and a communication apparatus 200 communicatively coupled to the electronic device 100. The electronic device 100 and the communication apparatus 200 both have a BLUETOOTH module and are able to communicate with each other via the BLUETOOTH modules. In the embodiment, the electronic device 100 can not dial or send messages without communicating with the communication apparatus 200, and is paired with the communication apparatus 200 by a matching code, when the electronic device 100 has been searched for by the communication apparatus 200, the communication apparatus 200 transmits a matching request with the matching code to the electronic device 100. A user inputs the matching code. The matching code is a combination of a number of numerals. In another embodiment, the matching code is a combination of a number of characters. In still another embodiment, the matching code is a combination of numerals and characters. The electronic device 100 verifies the matching code when the match request with matching codes from the communication apparatus 200 is received, and responds to the communication apparatus 200 when the matching codes are verified. Then, the electronic device 100 enters a communication mode with the communication apparatus 200. Then the electronic device 100 can dial or answer calls, and receive and send messages based upon the communication apparatus 200. In the embodiment, the electronic device 100 is a tablet computer, and the communication apparatus 200 is a mobile phone. In an alternative embodiment, the electronic device 100 can be other electronic devices with a display, such as a digital photo frame, a personal digital assistant, or a music player, and the communication apparatus 200 is a mobile phone.

The process of the electronic device 100 dialing or sending messages to a contact number via the communication apparatus 200 is illustrated as follows.

The electronic device 100 includes an input unit 10, a display unit 20, a BLUETOOTH unit 30, a storage unit 40, and a processor 50. The processor 50 connects the input unit 10, the display unit 20, the BLUETOOTH unit 30 and the storage unit 40.

The input unit 10 is configured for generating commands such as a dialing command or a send message command in response to operations of the user. In the embodiment, the input unit 10 is a touch input apparatus.

The BLUETOOTH unit 30 is configured for transmitting communication data with the communication apparatus 200.

The storage unit 40 is configured for storing a copy of a communication list of the communication apparatus 200. In the embodiment, the copy of the communication list is transmitted to the electronic device 100 from the communication apparatus 200.

The processor 50 includes a command receiving module 501, a dialing control module 502, a messaging control module 503, and a display module 504.

The command receiving module 501 is configured for receiving commands from the input unit 10.

The dialing control module 502 is configured for generating dial information when a dialing command from the command receiving module 501 is received. The dialing control module 502 is further configured for controlling the BLUETOOTH unit 30 to transmit dial information to the communication apparatus 200. In the embodiment, the dial information includes the contact number of the called person.

The messaging control module 503 is configured for controlling the BLUETOOTH unit 30 to transmit the message information to the communication apparatus 200, when the send message command from the command receiving module 501 is received. In the embodiment, the message information includes the contents of the message input by the user via the input unit 10, and the contact number of the message recipient.

The communication apparatus 200 includes a display unit 20′, a BLUETOOTH unit 30′, a processor 50′, and a wireless communication unit 60. The processor 50′ connects the display unit 20′, the BLUETOOTH unit 30′, and the wireless communication unit 60. The BLUETOOTH unit 30′ is configured for transmitting communication data with the electronic device 100. The wireless communication unit 60 is configured for communicating with other communication apparatus via GPRS or 3G.

The processor 50′ includes a dialing module 502′, a messaging module 503′, a display module 504′, and a status detecting module 505′.

The dialing module 502′ analyzes the dial information and controls the wireless communication unit 60 to dial according to the analyzed dialed information, after the dial information of the electronic device 100 is received by the BLUETOOTH unit 30′. The dialing module 502′ also controls the BLUETOOTH unit 30′ to transmit the real-time dial information to the electronic device 100. The real-time dial information includes a dial status selected from the group consisting of dialing, calling, and hang up, and the communication time period.

The dialing module 502′ analyzes the message information and controls the wireless communication unit 60 to send the message according to the analyzed message information, when the message information of the electronic device 100 is received via the BLUETOOTH unit 30′. The dialing module 502′ also controls the BLUETOOTH unit 30′ to transmit the real-time message send information to the electronic device 100. The real-time message send information includes the sending status, such as sending, or being sent and the sent time.

The status detecting module 505′ is configured for detecting the status of communication between the communication apparatus 200 and the other communication apparatus, and informing the dialing module 502′ or the messaging module 503′ when the status of the communication changes. In the embodiment, for example, once the status detecting module 505′ detects that the status of the communication between the communication apparatus 200 with the other communication apparatus becomes “calling” from “dialing”, the status detecting module 505′ informs the dialing module 502′. The dialing module 502′ controls the BLUETOOTH module 30′ to transmit the real-time dial information to the electronic device 100 immediately. And once the status detecting module 505′ detects that the status of the communication between the communication apparatus 200 with the other communication apparatus becomes “sent” from “sending”, the status detecting module 505′ informs the message module 502′. The message module 502′ controls the BLUETOOTH module 30′ to transmit the real-time message send information to the electronic device 100.

The dial control module 502 is further configured for controlling the BLUETOOTH unit 30 to transmit voice signals of the user to the communication apparatus 200.

The dialing module 502′ is further configured for controlling the wireless communication unit 60 to transmit the voice signals from the electronic device 100 to the other communication apparatus, and control the wireless communication unit 60 to transmit the voice signals from the other communication apparatus to the electronic device 100.

The process of the communication apparatus 200 transmitting real-time information of an incoming call and a received message to the electronic device 100 is illustrated as follows.

The status detecting module 505′ also detects whether the communication apparatus 200 receives an incoming call or an incoming message from other communication apparatus. The status detecting module 505′ controls the BLUETOOTH unit 30′ to transmit the real-time communication information between the communication apparatus 200 and the other communication apparatus to the electronic device 100, when the communication apparatus 200 receives an incoming call or an incoming message from the other communication apparatus.

The BLUETOOTH unit 30 of the electronic device 100 then transmits the communication information to the display module 504. The display module 504 controls the display unit 20 to display the communication information.

The input unit 10 generates commands for dealing with the incoming call or the incoming message in response to operations of the users. The commands for dealing with the incoming call includes commands for answering or refusing the incoming call, the commands for dealing with the incoming message includes commands for reading or replying the message.

The command receiving module 501 receives the commands from the input unit 10, and transmits the commands to the dialing control module 502 or the messaging control module 503 accordingly.

The dialing control module 502 controls the BLUETOOTH unit 30 to transmit the commands for dealing with the incoming call to the communication apparatus 200. The messaging control module 503 controls the BLUETOOTH unit 30 to transmit the commands for dealing with the incoming message and reply message information to the communication apparatus 200. The reply message information includes the contents of the reply to the message.

The BLUETOOTH unit 30′ of the communication apparatus 200 transmits the commands for dealing with the incoming call to the dialing module 502′. The dialing module 502′ controls the wireless communication unit 60 to deal with the incoming call, such as answer or refuse.

The BLUETOOTH unit 30′ also transmits the commands for replying to the message and the message information to the messaging module 503′. The messaging module 503′ controls the wireless communication unit 60 to send the reply to the other communication unit 60.

When the electronic device 100 communicates with the other communication apparatus based on the communication apparatus 200, the dialing module 502′ controls the BLUETOOTH unit 30′ to transmit the voice signals from the other communication apparatus to the electronic device 100. The dialing control module 502 controls the BLUETOOTH unit 30 to transmit the voice signals of the user to the communication apparatus 200. In addition, the dialing module 502′ controls the wireless communication unit 60 to transmit the voice signals of the user to the other communication apparatus.

The display module 504 further controls the display unit 20 to display the real-time communication information between the electronic device 100 and the communication apparatus 200.

With such configuration, the electronic device 100 communicates with the communication apparatus 200 via the BLUETOOTH, and communicates with other communication apparatus based upon the communication apparatus 200. The electronic device 100 can dial or send messages to other communication apparatus. The received communication information of the communication apparatus 200 is transmitted to the electronic device 100 in time, and the user can answer a call or read a message via the electronic device 100, which is convenient for the user.

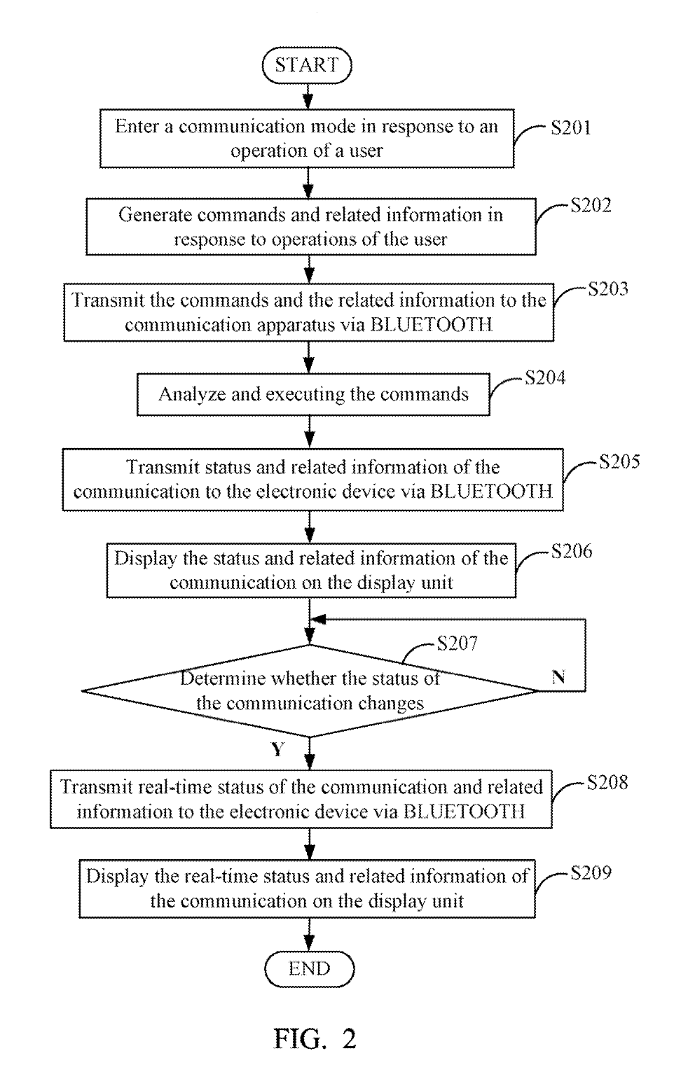

Referring to FIG. 2, FIG. 2 is a flow chart of a communication control method for the communication control system 1 of FIG. 1, showing the electronic device 100 communicating with other communication apparatus based upon the communication apparatus 200. The method includes the following steps, each of which is tied to various components contained in the communication control system 1 as shown in FIG. 1.

In step S201, the electronic device 100 enters a communication mode in response to an operation of a user. In the embodiment, the electronic device 100 can dial calls, answer calls, receive and send messages based upon the communication apparatus 200 under the communication mode.

In step S202, the input unit 10 generates commands and related information in response to operations of the user. In the embodiment, the input unit 10 generates commands such as a dialing command or a send message command and related information in response to the corresponding operations of the user.

In step S203, the electronic device 100 transmits the commands and the related information to the communication apparatus 200 via BLUETOOTH.

In step S204, the communication apparatus 200 analyzes and executes the commands

In step S205, the communication apparatus 200 transmits status and related information of the communication to the electronic device 100 via BLUETOOTH.

In step S206, the display unit 20 of the electronic device 100 displays the status and related information of the communication.

In step S207, the status detecting module 505′ determines whether the status of the communication changes, if yes, the process goes to step S208, otherwise, the process goes back to step S207.

In step S208, the communication apparatus 200 transmits real-time status of the communication and related information to the electronic device 100 via BLUETOOTH.

In step S209, the display unit 20 of the electronic device 100 displays the real-time status and related information of the communication.

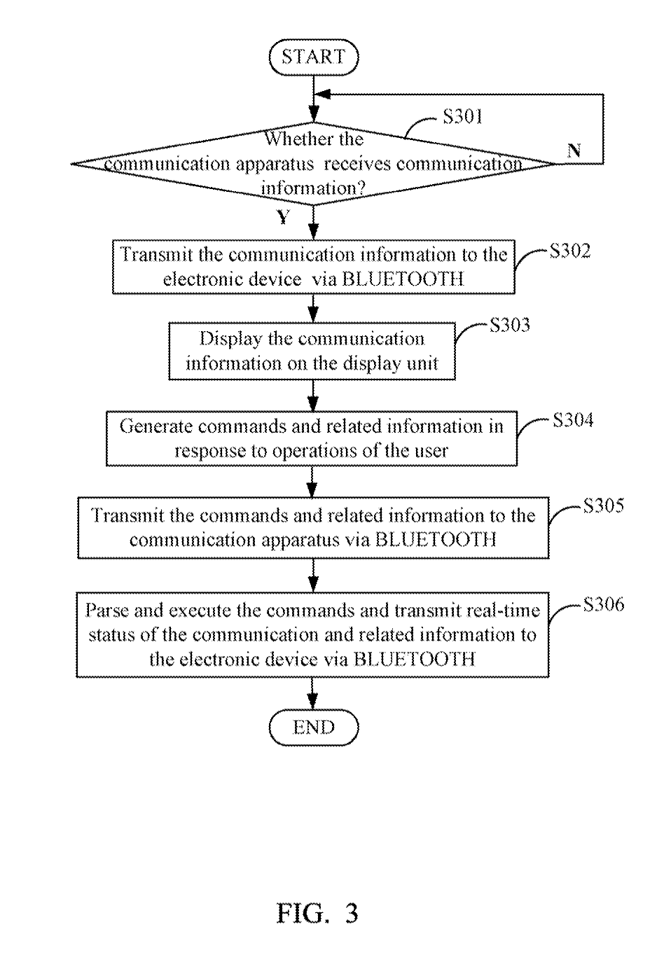

Referring to FIG. 3, a flow chart of a communication control method for the communication control system 1 of FIG.1 is shown, showing the communication apparatus 200 transmitting the real-time status of communication to the electronic device 100. The method includes the following steps, each of which is tied to various components contained in the communication control system 1 as shown in FIG. 1.

In step S301, the status detecting module 505′ detects whether the communication apparatus 200 receives communication information, if yes, the process goes to step S302, otherwise, the process goes back to step S301.

In step S302, the status detecting module 505′ transmits the communication information to the electronic device 100 via BLUETOOTH.

In step S303, the display unit 20 of the electronic device 100 displays the communication information.

In step S304, the input unit 10 generates commands and related information in response to operations of the user.

In step S305, the electronic device 100 transmits the commands and related information to the communication apparatus 200 via BLUETOOTH.

In step S306, the communication apparatus 200 analyzes and executes the commands and transmits real-time status of the communication and related information to the electronic device 100 via BLUETOOTH.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A communication control system, comprising:
an electronic device, comprising:
an input unit configured for generating commands in response to operations of a user;
a first BLUETOOTH unit; and
a dialing control module configured for generating a dial information when a dialing command is received; and
a communication apparatus, the dialing control module configured for controlling the first BLUETOOTH unit to transmit the dial information to the communication apparatus, the communication apparatus comprising:
a wireless communication unit;
a second BLUETOOTH unit; and
a dialing module configured for controlling the wireless communication unit to dial according to the dial information and controlling the second BLUETOOTH unit to transmit real-time dial information and voice signals of the user to the electronic device.

2. The communication control system as described in claim 1, wherein the electronic device further comprises a messaging control module configured for controlling the first BLUETOOTH unit to transmit a send message command and message information to the communication apparatus, when the send message command from the input unit is received; and the communication apparatus further comprises a message module configured for controlling the wireless communication unit to send messages, when the send message command and message information from the electronic device is received.

3. The communication control system as described in claim 2, wherein the message information comprises contents of the message input by the user, and a contact number of a message recipient.

4. The communication control system as described in claim 2, wherein the communication apparatus further comprises a status detecting module configured for detecting communication status of the communication apparatus, and informing the dialing module or the message module accordingly when the communication status of the communication apparatus changes; and the message module is further configured for controlling the second BLUETOOTH unit to transmit real-time message sending information to the electronic device.

5. The communication control system as described in claim 4, wherein the electronic device further comprises a display unit configured for displaying the communication status of the communication apparatus when the communication status is received.

6. The communication control system as described in claim 4, wherein the communication status of the communication apparatus comprises calling, dialing and sending.

7. The communication control system as described in claim 4, wherein the status detecting module is further configured for detecting whether the communication apparatus receives communication information, and controlling the second BLUETOOTH unit to transmit real-time communication information of the communication apparatus when the communication apparatus receives the communication information.

8. The communication control system as described in claim 7, wherein the communication information comprises incoming calls and messages.

9. The communication control system as described in claim 1, wherein the dial information comprises a contact number of a called person.

10. The communication control system as described in claim 1, wherein the real-time dial information comprises a dial status selected from the group consisting of dialing, calling, and hang up, and a communication time period.

11. The communication control system as described in claim 1, wherein the electronic device is a digital photo frame or a tablet computer.

12. The communication control system as described in claim 1, wherein the communication apparatus is a mobile phone.

13. A communication control method for a communication control system, the communication control system comprising an electronic device and a communication apparatus communicatively coupled to the electronic device, the electronic device comprising a display unit and a BLUETOOTH unit, and communicating with the communication apparatus via the BLUETOOTH unit, the method comprising:
entering a communication mode;
generating commands and related information in response to operations of a user;
transmitting the commands and the related information to the communication apparatus via BLUETOOTH;
analyzing and executing the commands using the communication apparatus;
transmitting status and related information of the communication to the electronic device via BLUETOOTH; and
displaying the status and related information of the communication on the display unit.

14. The method as described in claim 13, further comprising the steps of:
determining whether communication status of the communication apparatus changes;
transmitting real-time status of the communication and related information to the electronic device via BLUETOOTH when the communication status of the communication apparatus changes; and
displaying the real-time status and related information of the communication on the display unit.

15. The method as described in claim 13, wherein the real-time status of the communication comprises a dial status selected from the group consisting of dialing, calling and hang up, and the related information includes a communication time period.

16. The method as described in claim 13, further comprising the steps of:
detecting whether the communication apparatus receives communication information;
transmitting the communication information to the electronic device via BLUETOOTH; and
displaying the communication information on the display unit.

17. The method as described in claim 16, wherein the communication information comprises incoming calls and messages.
